(19) United States
(12) Patent Application Publication
(10) Pub. No.: US 2026/0158925 A1
(43) Pub. Date: Jun. 11, 2026

(54) IN-VEHICLE BATTERY SYSTEM

(71) Applicant: Prime Planet Energy & Solutions, Inc., Tokyo (JP)

(72) Inventor: Kimihiko FURUKAWA, Kakogawa-shi (JP)

(21) Appl. No.: 19/409,733

(22) Filed: Dec. 5, 2025

(30) Foreign Application Priority Data
Dec. 9, 2024 (JP) 2024-214459

(51) Int. Cl. B60L 3/00; B60L 3/04; B60L 50/64; H01M 50/24

(52) U.S. Cl. CPC B60L 3/0046; B60L 3/04; B60L 50/64; H01M 50/24

(57) ABSTRACT

A control device of an in-vehicle battery system disclosed herein includes: an acquisition unit that acquires a degradation progression degree of a power supply module based on a usage status of the power supply module; a detection unit that detects presence or absence of leakage in the power supply module; a determination unit that determines whether the degradation progression degree exceeds an expected lifetime when leakage is detected by the detection unit; and a usage stopping unit that stops the usage of power supplied from the power supply module to the drive load when the degradation progression degree is determined to have exceeded the expected lifetime. According to the in-vehicle battery system with this configuration, risks associated with leakage in the power supply module can be suitably reduced.

### CROSS REFERENCE TO RELATED APPLICATIONS

This application claims the benefit of priority to Japanese Patent Application Publication No. 2024-214459 filed on Dec. 9, 2024. The entire contents of this application are hereby incorporated herein by reference.

### BACKGROUND

### 1. Technical Field

The technology disclosed herein relates to an in-vehicle battery system.

### 2. Description of the Related Art

In-vehicle batteries used in electric vehicles and the like are used in the form of a power supply module in which various components are attached to a power supply (such as a secondary battery). For the purpose of ensuring safety, leakage detection technology is sometimes adopted in such power supply modules (see, e.g., Japanese Patent Application Publication Nos. 2023-081521 and 2023-081523). Furthermore, Japanese Patent Application Publication No. 2005-057965 discloses a power conversion apparatus that is capable of detecting whether a leakage detection means is abnormal or not and continuing power supply without suspension when the leakage detection means is determined to be in a normal state.

### SUMMARY

In recent years, in response to increasing demands for the safety of power supply modules, there has been a need for the development of systems that can further reduce risks associated with leakage. An in-vehicle battery system disclosed herein has been made based on such demand.

The in-vehicle battery system disclosed herein includes: a power supply module connected to a drive load of a vehicle; and a control device that controls charging and discharging of the power supply module. The control device includes: an acquisition unit that acquires a degradation progression degree of the power supply module based on a usage status of the power supply module; a detection unit that detects presence or absence of leakage in the power supply module; a determination unit that determines whether the degradation progression degree exceeds a predetermined expected lifetime when leakage is detected by the detection unit; and a usage stopping unit that stops usage of power supplied from the power supply module to the drive load when the determination unit determines that the degradation progression degree has exceeded the expected lifetime.

The inventors have diligently studied ways to reduce risks associated with leakage in an in-vehicle battery and have reached the following findings. First, since a driver does not directly touch a power supply module while the vehicle is running, the risk of electric shock in the event of leakage is relatively low. On the other hand, if the power supply to a running vehicle is suddenly stopped, there are risks such as an accident caused by sudden stopping of the vehicle or the need to tow the vehicle with a wrecker. From these perspectives, it is considered preferable not to immediately stop power supply to the vehicle even when leakage is detected during running of the vehicle. However, each component of the power supply module has its own lifetime. If leakage occurs after the lifetime has expired, a high-risk abnormality such as smoke emission or ignition may occur in the power supply. When such leakage occurs with the lifetime having expired, the vehicle should be brought to a sudden stop, thereby stopping the usage of power.

The in-vehicle battery system disclosed herein has been made based on the above-mentioned findings. The determination unit of the in-vehicle battery system determines whether the degradation progression degree of the power supply module exceeds the expected lifetime when detecting leakage. The usage stopping unit stops usage of power supplied from the power supply module to the drive load when the determination unit determines that the degradation progression degree has exceeded the expected lifetime. Thus, high-risk abnormalities such as smoke emission and ignition can be prevented, because the usage of power can be stopped when leakage occurs in components that have failed due to the expiration of their lifetime. Furthermore, when the lifetime of the power supply module has not expired, the in-vehicle battery system does not stop the usage of power supplied to the vehicle merely because leakage is detected. Thus, risks associated with sudden stopping of the vehicle can be reduced. As described above, according to the in-vehicle battery system disclosed herein, risks associated with leakage in the power supply module can be suitably reduced.

### BRIEF DESCRIPTION OF THE DRAWINGS

FIG. 1 is a schematic diagram illustrating an in-vehicle battery system according to a first embodiment.

FIG. 2 is a circuit diagram illustrating a leakage detection circuit of the in-vehicle battery system according to the first embodiment.

FIG. 3 is a cross-sectional view illustrating a waterproof case of the in-vehicle battery system according to the first embodiment.

FIG. 4 is a flowchart explaining control of the in-vehicle battery system during running of a vehicle according to the first embodiment.

FIG. 5 is a flowchart explaining control of the in-vehicle battery system at the start of running of the vehicle according to the first embodiment.

### DETAILED DESCRIPTION

Hereinafter, embodiments of the technology disclosed herein will be described. Matters other than those specifically mentioned in the present specification that are necessary for implementing the technology disclosed herein may be understood as design matters of those skilled in the art based on the conventional technology in the field. The technology disclosed herein is implementable based on the contents disclosed in the present specification and the common technical knowledge in the field. It should be noted that the expression “A to B” indicating a range in the present specification includes not only the meaning of A or more and B or less, but also the meanings of “preferably greater than A” and “preferably less than B”.

### First Embodiment

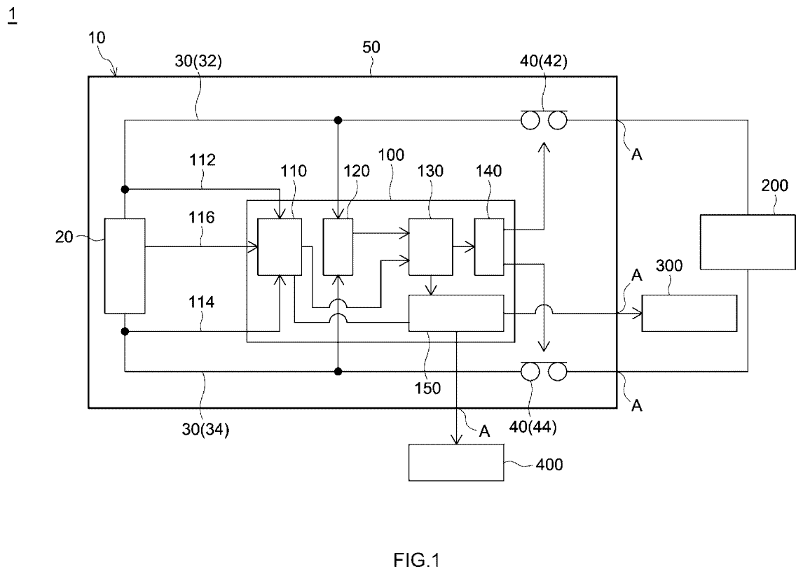

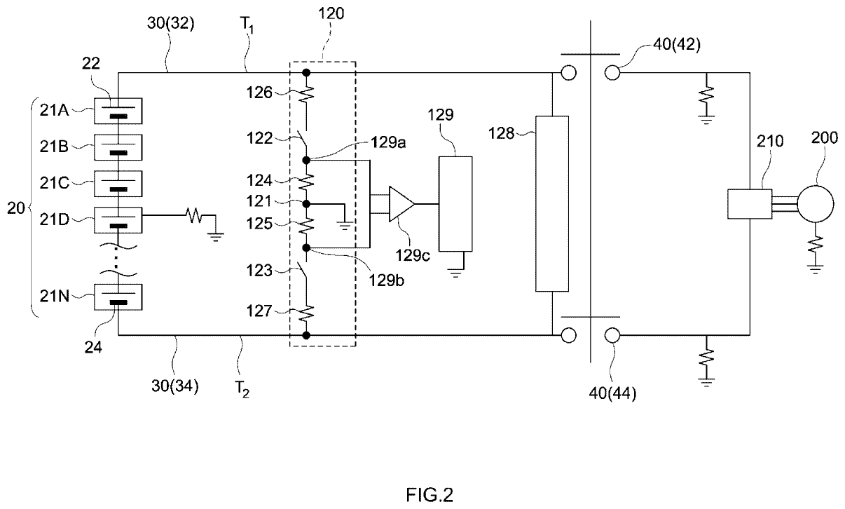

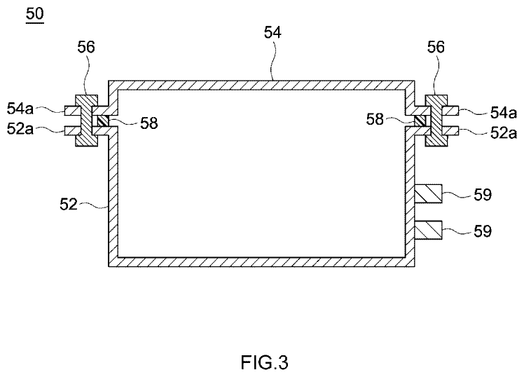

One embodiment of an in-vehicle battery system disclosed herein will be described below with reference to FIGS. 1 to 3. FIG. 1 is a schematic diagram illustrating an in-vehicle battery system according to a first embodiment. FIG. 2 is a circuit diagram illustrating a leakage detection circuit of the in-vehicle battery system according to the first embodiment. FIG. 3 is a cross-sectional view illustrating a waterproof case of the in-vehicle battery system according to the first embodiment.

### A. Configuration of In-Vehicle Battery System

As illustrated in FIG. 1, an in-vehicle battery system 1 according to the present embodiment includes a power supply module 10 and a control device 100. The respective configurations thereof will be described below.

### 1. Power Supply Module 10

As illustrated in FIG. 1, the power supply module 10 is connected to a drive load 200 of a vehicle (not illustrated). The drive load 200 is a mechanism that converts the power supplied from the power supply module 10 into driving power. This enables the vehicle to run. The specific structure of the drive load 200 is not particularly limited and may be selected as appropriate from conventionally known devices (such as a motor).

Although not intended to limit the technology disclosed herein, the power supply module 10 includes, for example, a power supply 20, a conductive path 30, contactors 40, and a waterproof case 50. The components forming the power supply module 10 will be described below.

### (1) Power Supply 20

The power supply 20 is a power supply source for the vehicle. The power supply 20 of the present embodiment is a battery pack including a plurality (N) of battery cells 21A to 21N (see FIG. 2). In this power supply (battery pack) 20, the respective battery cells 21A to 21N are arranged so as to be adjacent to each other along a predetermined arrangement direction. Two adjacent battery cells are electrically connected to each other by a connecting member. Note that a positive terminal of the first battery cell 21A disposed at one end of the power supply 20 is not connected to the other battery cells. Such a positive terminal of the first battery cell 21A serves as a main positive terminal 22 that is open to be connectable to the drive load 200. Meanwhile, a negative terminal of the nth battery cell 21N disposed at the other end of the power supply 20 is also not connected to the other battery cells. Such a negative terminal of the nth battery cell 21N serves as a main negative terminal 24 that is open to be connectable to the drive load 200.

Note that the term “battery cell” as used herein refers to a device capable of charging and discharging. Examples of such battery cells include: secondary batteries such as lithium-ion secondary batteries, nickel-metal hydride batteries, and nickel-cadmium batteries; primary batteries such as manganese dry batteries and alkaline dry batteries; capacitors such as electric double-layer capacitors; and power generation elements such as fuel cells and solar cells. The number of battery cells forming the power supply 20 is not particularly limited and may be changed as appropriate according to the performance (output voltage, installation space, etc.) required for the power supply module 10. For example, the power supply 20 may be composed of a single battery cell. However, in consideration of the performance of the power supply module 10, the number of battery cells forming the power supply 20 is preferably 50 or more, more preferably 75 or more, even more preferably 90 or more, and particularly preferably 100 or more. The upper limit of the number of battery cells is not particularly limited and may be 200 or less, or 150 or less.

### (2) Conductive Path 30

As illustrated in FIG. 1, the conductive path 30 connects the power supply 20 and the drive load 200. In the present embodiment, the conductive path 30 includes a positive electrode conductive path 32 connecting a positive electrode of the power supply 20 and the drive load 200, and a negative electrode conductive path 34 connecting a negative electrode of the power supply 20 and the drive load 200. Specifically, as illustrated in FIG. 2, the positive electrode conductive path 32 is connected to the main positive terminal 22 of the first battery cell 21A. Meanwhile, the negative electrode conductive path 34 is connected to the main negative terminal 24 of the nth battery cell 21N.

### (3) Contactor 40

The contactors 40 are provided in the conductive path 30 and switch ON and OFF the connection between the power supply 20 and the drive load 200. In the present embodiment, the power supply module 10 includes a pair of contactors 40 on the positive electrode side and the negative electrode side. Specifically, a positive electrode-side contactor 42 is attached onto the positive electrode conductive path 32. Meanwhile, a negative electrode-side contactor 44 is attached onto the negative electrode conductive path 34. The structure of the contactor 40 is not particularly limited, and any contactor usable for forming this kind of electrical circuit may be used without particular restriction. As described in detail later, the positive electrode-side contactor 42 and the negative electrode-side contactor 44 are connected to a usage stopping unit 140 of the control device 100. The positive electrode-side contactor 42 and the negative electrode-side contactor 44 are configured so as to be switched between ON and OFF by a signal from the usage stopping unit 140. For example, a normally-closed type contactor may be used for the positive electrode-side contactor 42 and the negative electrode-side contactor 44. This type of contactor connects the power supply 20 and the drive load 200 when no stop signal is input from the usage stopping unit 140, but disconnects the power supply 20 from the drive load 200 when the stop signal is input. As another example of the contactor 40, a normally-open type contactor may be used. This type of contactor disconnects the power supply 20 from the drive load 200 when no connection signal is input, but connects the power supply 20 and the drive load 200 when the connection signal is input.

### (4) Waterproof Case 50

As illustrated in FIG. 1, the power supply module 10 of the present embodiment includes the waterproof case 50 that accommodates the power supply 20, the conductive path 30, and the contactors 40. This configuration can prevent large-scale leakage from occurring due to immersion of conductive components (the power supply 20, the conductive path 30, and the contactors 40) in water within the power supply module 10.

As illustrated in FIG. 3, the waterproof case 50 of the present embodiment includes a case body 52, a lid 54, fixing bolts 56, and a gasket 58. The case body 52 is a box-shaped member with an open top surface. A flange portion 52a extending outward from the case body 52 is provided at an upper end of the case body 52. The flange portion 52a is formed along the entire periphery of the upper end of the case body 52. Meanwhile, the lid 54 is a plate-shaped member that closes the opening at the upper surface of the case body 52. An outer peripheral edge 54a of the lid 54 is disposed to face the flange portion 52a of the case body 52. The fixing bolts 56 penetrate through the outer peripheral edge 54a of the lid 54 and the flange portion 52a of the case body 52. Thus, the case body 52 and the lid 54 can be fixed together. Note that a plurality of fixing bolts 56 (e.g., four or more) are preferably attached in the circumferential direction around the case body 52. From the viewpoint of preventing leakage into the waterproof case 50, the case body 52 and the lid 54 are preferably formed of an insulating resin material (e.g., PP, PE, ABS resin). The gasket 58 is an annular member formed of an elastic material (e.g., SBR, IIR). The gasket 58 is disposed between the outer peripheral edge 54a of the lid 54 and the flange portion 52a of the case body 52 along the entire periphery of the case body 52. Thus, the interior of the waterproof case 50 is sealed. Further, the waterproof case 50 illustrated in FIG. 3 includes a plurality of waterproof connectors 59. The normal power supply module 10 is provided with a plurality of lead-out portions A for drawing out a conductive cable (conductive path 30) and a communication cable from the inside of the waterproof case 50 to the outside thereof. Provision of the waterproof connectors 59 at these lead-out portions A enables more suitable prevention of moisture intrusion into the interior of the waterproof case 50.

### 2. Control Device 100

The control device 100 is a device that controls charging and discharging of the power supply module 10. As illustrated in FIG. 1, the control device 100 includes an acquisition unit 110, a detection unit 120, a determination unit 130, and the usage stopping unit 140. In addition, the control device 100 of the present embodiment further includes a communication means 150. The configuration of the control device 100 will be described below.

### (1) Acquisition Unit 110

The acquisition unit 110 acquires a degradation progression degree D of the power supply module 10 based on its usage status. The degradation progression degree D acquired by the acquisition unit 110 is transmitted to the determination unit 130. In the present specification, the “degradation progression degree D” is a numerical value representing the degradation state of components of the power supply module 10, quantified based on the usage status of the power supply module 10. For example, the degradation progression degree D is preferably calculated based on factors such as a cumulative operating time TT of the in-vehicle battery system 1, a cumulative running distance TD of the vehicle, and a cumulative charge-discharge current integrated value TE of the power supply module 10 (typically of the power supply 20).

For example, the cumulative operating time TT of the in-vehicle battery system 1 can be measured with a timer installed in the control device 100. Specifically, the acquisition unit 110 measures, as the cumulative operating time TT, the integrated value of the time during which the contactor 40 is ON (i.e., the time during which power is being supplied from the power supply 20 to the drive load 200). When the cumulative operating time TT is adopted as the degradation progression degree D, an expected lifetime L described later is set in terms of “time (h)” corresponding to the cumulative operating time TT. Note that when the cumulative operating time TT is adopted as the degradation progression degree D, the acquisition unit 110 may also measure a standby time T1 during which the contactor 40 is OFF. In addition, a corrected value of the cumulative operating time TT, which has been corrected using the standby time T1, may be adopted as the degradation progression degree D. This enables comprehensive evaluation of the degradation degree in consideration of the standby time T1 as well.

Next, the cumulative running distance TD of the vehicle is measured in an Engine Control Unit (ECU) 300. Therefore, by connecting the acquisition unit 110 to the ECU 300 via the communication means 150, the acquisition unit 110 can acquire the cumulative running distance TD. When this cumulative running distance TD is adopted as the degradation progression degree D, the expected lifetime L is set in terms of “distance (km)” corresponding to the cumulative running distance TD. The cumulative running distance TD may also be corrected using the standby time T1. This enables comprehensive evaluation of the degradation degree in consideration of the standby time T1 as well.

As illustrated in FIG. 1, the acquisition unit 110 is connected to the power supply 20 via a voltage detection line 112 and a current detection line 114. Thus, the cumulative charge-discharge current integrated value TE of the power supply module 10 can be acquired. When this cumulative charge-discharge current integrated value TE is adopted as the degradation progression degree D, the expected lifetime L is set in terms of a specific “current integrated value (Ah)”. The cumulative charge-discharge current integrated value TE can also be converted into the cumulative running distance TD. In this case, the expected lifetime L can be set in terms of “distance (km)”.

Furthermore, the acquisition unit 110 of the present embodiment is connected to the power supply 20 via a temperature detection line 116. Thus, the temperature profile of the power supply 20 can be acquired. Corrected values of the above-described cumulative operating time TT, cumulative running distance TD, and cumulative charge-discharge current integrated value TE, corrected using the temperature profile of the power supply 20, may each be adopted as the degradation progression degree D. This enables accurate reflection of degradation degree associated with the temperature environment.

The acquisition unit 110 of the present embodiment may also be connected to the contactor 40 (not illustrated). Thus, the acquisition unit 110 can acquire the number of operations (number of ON/OFF switching operations) of the contactor 40. The number of operations of the contactor 40 affects the degradation of the contactor 40. Therefore, corrected values of the above-described cumulative operating time TT, cumulative running distance TD, and cumulative charge-discharge current integrated value TE, corrected using the number of operations of the contactor 40, may each be adopted as the degradation progression degree D. This enables estimation of the degradation degree of the power supply module 10 based on the degradation degree of the contactor 40.

The power supply module 10 is composed of a plurality of components (including the power supply 20, the conductive path 30, the contactors 40, the waterproof case 50, and the like). At this time, the user of the system can freely designate which component's degradation progression degree is to be regarded as the “degradation progression degree D of the power supply module 10”. For example, the acquisition unit 110 may be configured to select any component from the components of the power supply module 10, and set the degradation progression degree of the selected component as the “degradation progression degree D of the power supply module 10”. For example, the acquisition unit 110 is preferably configured to regard the degradation progression degree of the waterproof case 50 as the “degradation progression degree D of the power supply module 10”. As described above, the power supply module 10 of the present embodiment prevents leakage due to immersion in water by accommodating the conductive components, such as the power supply 20, the conductive path 30, and the contactors 40 within the waterproof case 50. However, if the lifetime of the waterproof case 50 expires, large-scale leakage may occur in the conductive component, leading to high-risk abnormality, such as smoke emission or ignition. In contrast, by regarding the degradation progression degree of the waterproof case 50 as the “degradation progression degree D of the power supply module 10”, the occurrence of a high-risk abnormality can be prevented more suitably.

The degradation progression degree D of the power supply module 10 is not necessarily limited to the degradation progression degree of a specific component. Specifically, the acquisition unit 110 may acquire the degradation progression degree of each of the components of the power supply module 10 (including the power supply 20, the conductive path 30, the contactors 40, the waterproof case 50, and the like). In this case, the acquisition unit 110 preferably regards the degradation progression degree of the most degraded component as the “degradation progression degree D of the power supply module 10”. This can more suitably reduce the risk of continuing to use a component whose lifetime has expired.

As will be described in detail later, the detection unit 120 of the control device 100 may also be configured to identify a component in which leakage has occurred. In this case, the acquisition unit 110 may select the degradation progression degree that is to be regarded as the “degradation progression degree D of the power supply module 10” based on the component in which leakage is detected.

### (2) Detection Unit 120

The detection unit 120 is a circuit that detects the presence or absence of leakage in the power supply module 10. The detection unit 120 only needs to be able to detect leakage in at least a part of the conductive components (such as the power supply 20, the conductive path 30, and the contactor 40) of the power supply module 10, and conventionally known leakage detection devices may be used therefor without particular restriction.

For example, the detection unit 120 of the present embodiment is connected between the positive electrode conductive path 32 and the negative electrode conductive path 34. The detection unit 120 is connected to the ground at an intermediate point 121. That is, the intermediate point 121 of the detection unit 120 is configured to be conductively connected to a leakage location via the ground when leakage occurs in the power supply module 10.

In addition, the detection unit 120 is configured to detect a first ground voltage Vg(t1), which is a potential difference between the positive electrode conductive path 32 and the leakage location via the ground, and a second ground voltage Vg(t2), which is a potential difference between the negative electrode conductive path 34 and the leakage location via the ground. Specifically, the detection unit 120 includes two switching elements consisting of a first switch 122 and a second switch 123, and four resistors consisting of a first voltage detection resistor 124, a second voltage detection resistor 125, a first voltage-dividing resistor 126, and a second voltage-dividing resistor 127.

The first switch 122 is a switching element connected closer to the positive electrode conductive path 32 side than the intermediate point 121. Meanwhile, the second switch 123 is a switching element connected closer to the negative electrode conductive path 34 side than the intermediate point 121. The structures of these switching elements are not particularly limited, and semiconductor switching elements such as transistors or FETs, or mechanical switches such as relays, may be used. The detection unit 120 controls the operations of the respective switching elements such that the second switch 123 is turned OFF when the first switch 122 is turned ON, whereas the first switch 122 is turned OFF when the second switch 123 is turned ON.

Next, the four resistors provided in the detection unit 120 will be described. The first voltage detection resistor 124 is a resistor provided between the first switch 122 and the intermediate point 121. The second voltage detection resistor 125 is a resistor provided between the second switch 123 and the intermediate point 121. Further, the first voltage-dividing resistor 126 is a resistor provided between the positive electrode conductive path 32 and the first switch 122. The second voltage-dividing resistor 127 is a resistor provided between the negative electrode conductive path 34 and the second switch 123. In the present embodiment, the first voltage detection resistor 124 and the second voltage detection resistor 125 are each set to the same resistance Ra. In addition, the first voltage-dividing resistor 126 and the second voltage-dividing resistor 127 are each set to the same resistance Rb. However, the respective resistors described above may have different electrical resistances.

Next, the detection unit 120 includes a voltage detection unit 129. The voltage detection unit 129 is connected to a first connection point 129a provided between the first switch 122 and the first voltage detection resistor 124, and to a second connection point 129b provided between the second switch 123 and the second voltage detection resistor 125. A differential operation circuit 129c is disposed between the first connection point 129a (the second connection point 129b) and the voltage detection unit 129. The voltage detection unit 129 of the present embodiment detects four types of ground voltages Vg, namely, a first ground voltage Vg(t1), a second ground voltage Vg(t2), a third ground voltage Vg(t3), and a fourth ground voltage Vg(t4), based on the input voltage. The procedure for detecting these ground voltages Vg is disclosed in Japanese Patent Application Publication No. 2023-081523, and thus a redundant description thereof is omitted.

Further, the detection unit 120 of the present embodiment includes a reference potential difference detection unit 128. The reference potential difference detection unit 128 is connected between the positive electrode conductive path 32 and the negative electrode conductive path 34, and detects a reference potential difference Vs, which is the potential difference between the positive electrode conductive path 32 and the negative electrode conductive path 34. Note that the specific structure of the reference potential difference detection unit 128 is not particularly limited, and any conventionally known voltage detection unit may be applied thereto without particular restriction. The detection unit 120 can identify a leakage occurrence portion inside the power supply module 10 based on the reference potential difference Vs detected by the reference potential difference detection unit 128 and the four types of ground voltages Vg acquired by the voltage detection unit 129. The identification procedure in this case is also disclosed in Japanese Patent Application Publication No. 2023-081523, and a redundant description thereof is omitted.

### (3) Determination Unit 130

The determination unit 130 determines whether the degradation progression degree D exceeds a predetermined expected lifetime L when leakage is detected by the detection unit 120. Specifically, the determination unit 130 is connected to the acquisition unit 110. Thus, the degradation progression degree D acquired by the acquisition unit 110 is transmitted to the determination unit 130. The determination unit 130 is also connected to the detection unit 120. Thus, the leakage information acquired by the detection unit 120 is also transmitted to the determination unit 130. These pieces of information are stored in a storage area of the determination unit 130.

The storage area of the determination unit 130 also stores the expected lifetime L, which is a threshold for the degradation progression degree D. As described in detail later, this expected lifetime L serves as a criterion for determining whether to stop the usage of power from the power supply module 10 when leakage information is transmitted from the detection unit 120. Such an expected lifetime L can be set as appropriate by a system user according to his/her purpose. For example, either the design lifetime or the guaranteed lifetime is preferably set as the expected lifetime L. The design lifetime is a usage limit period calculated based on the service life of the components of the power supply module 10. When the design lifetime is set as the expected lifetime L, the power supply module 10 can be used until the service life of the components, which contributes to reduction of the operating cost of the in-vehicle battery system 1. On the other hand, the guaranteed lifetime is a period shorter than the design lifetime, set as the period for guaranteeing the safety of the power supply module 10. When the guaranteed lifetime is set as the expected lifetime L, the in-vehicle battery system 1 with enhanced safety can be constructed.

### (4) Usage Stopping Unit 140

When the determination unit 130 determines that the degradation progression degree D has exceeded the expected lifetime L (D>L), the usage stopping unit 140 stops the usage of power supplied from the power supply module 10 to the drive load 200. The usage stopping unit 140 of the present embodiment is configured to control the contactor 40 so as to turn OFF the connection between the power supply 20 and the drive load 200 when D>L is determined. Specifically, the usage stopping unit 140 is connected to the determination unit 130 and the contactors 40. The usage stopping unit 140 can generate a stop signal that turns OFF the contactor 40. When the determination result indicating that the lifetime has ended (D>L) is received from the determination unit 130, the usage stopping unit 140 transmits the stop signal to the contactors 40. Consequently, the supply of power from the power supply 20 to the drive load 200 is interrupted. As a result, this can prevent the power supply module 10 from continuing to be used after its lifetime has expired, even though leakage has occurred.

The usage stopping unit 140 is preferably configured to stop the usage of power supplied from the power supply module 10 to the drive load 200 after a predetermined evacuation time has elapsed when the determination unit 130 determines that the degradation progression degree D has exceeded the expected lifetime L. Specifically, the usage stopping unit 140 of the present embodiment has a predetermined evacuation time (about 30 to 60 seconds) set. When the determination result indicating that the lifetime has ended (D>L) is received from the determination unit 130, the usage stopping unit 140 transmits a stop signal to the contactors 40 after the above-described evacuation time has elapsed. This can prevent accidents due to sudden stopping of the vehicle. Moreover, such a configuration can ensure sufficient time for the driver to evacuate the vehicle.

### (5) Communication Means 150

The communication means 150 is a device for exchanging various data between external devices and the control device 100 of the in-vehicle battery system 1. For example, in the in-vehicle battery system 1 illustrated in FIG. 1, the ECU 300 and a notification unit 400 are connected to the control device 100 via the communication means 150. This allows mutual exchange of data between the devices. Note that the communication means 150 is not particularly limited, and any conventionally known communication device may be used without particular restriction. For example, the communication means 150 may be a wired or wireless communication means. The communication means 150 can notify the vehicle control side that a forced stop is performed by stopping the usage of power after the predetermined evacuation time based on the determination result of the determination unit 130. This allows the driver to be informed that the vehicle should be brought into an evacuation running state.

The acquisition unit 110, the determination unit 130, the usage stopping unit 140, and the communication means 150 may be implemented by a single microcomputer. This microcomputer includes a Central Processing Unit (CPU) that executes control programs, a Read Only Memory (ROM) that stores programs to be executed by the CPU, a Random Access Memory (RAM) used as a working area for program expansion, and a storage device, such as a memory, for storing programs and various data. The determination unit 130, the usage stopping unit 140, and the communication means 150 may be constructed by a plurality of devices cooperating with one another.

In the in-vehicle battery system 1 illustrated in FIG. 1, the control device 100 is also accommodated in the waterproof case 50. This can prevent immersion of the control device 100 into water. Further, the control device 100 is preferably disposed at the highest position inside the waterproof case 50. In addition, the control device 100 preferably has its surface subjected to waterproof treatment. These measures can more reliably prevent immersion of the control device 100 into water. However, the installation position of the control device 100 can be changed as appropriate, depending on the structure of the vehicle or the like, and the technology disclosed herein is not limited thereto. For example, the acquisition unit 110, the determination unit 130, the usage stopping unit 140, and the communication means 150 may be incorporated in a vehicle-side control device (e.g., ECU 300).

### 3. Notification Unit 400

The in-vehicle battery system 1 according to the present embodiment further includes the notification unit 400 that notifies the user of leakage when the leakage is detected by the detection unit 120. This can further improve the safety of the in-vehicle battery system 1. Specifically, by notifying the user of occurrence of the leakage in advance, the likelihood of avoiding accidents due to sudden stopping increases. Moreover, when the lifetime of the power supply module 10 has not expired, the in-vehicle battery system 1 according to the present embodiment does not stop the usage of power supplied to the drive load 200 even if leakage occurs. At this time, notifying the user of the occurrence of leakage can prompt voluntary inspection and repair. Note that the notification unit 400 only needs to be capable of notifying the user of leakage detection, and its specific configuration is not particularly limited. For example, the notification unit 400 may be an image display device or a voice notification device.

### B. Control During Running of Vehicle

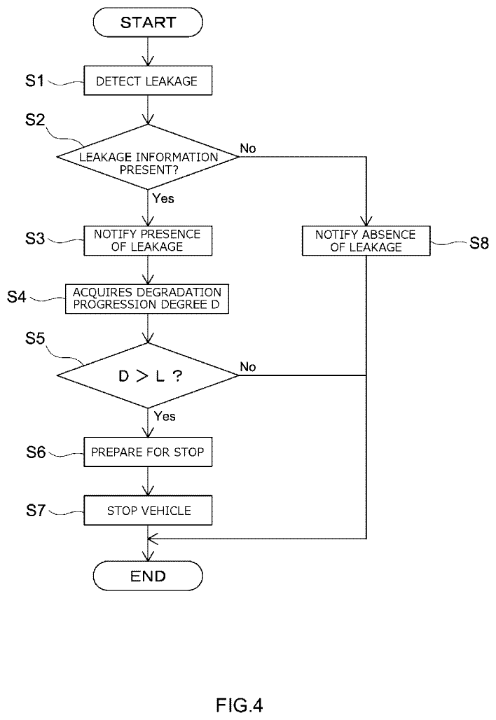

The configuration of the in-vehicle battery system 1 according to the present embodiment has been described above. Next, the operation of the in-vehicle battery system 1 during running of the vehicle will be described. FIG. 4 is a flowchart illustrating control of the in-vehicle battery system during running of the vehicle according to the first embodiment.

As illustrated in FIG. 4, a control method for the vehicle includes a leakage detection step S1, a leakage determination step S2, a leakage notification step S3, a lifetime acquisition step S4, a lifetime determination step S5, a stop preparation step S6, and a stop step S7. Each step will be described below.

### (1) Leakage Detection Step S1

In the leakage detection step S1, the detection unit 120 detects leakage in the power supply module 10. When leakage is detected on the power supply module 10 side, the detection unit 120 switches the switching elements 122 and 123 as appropriate, thereby acquiring four types of ground voltages Vg(t1) to Vg(t4). The detection unit 120 then acquires a reference potential difference Vs in the reference potential difference detection unit 128. Based on the four types of ground voltages Vg(t1) to Vg(t4) and the reference potential difference Vs, the detection unit 120 performs leakage detection of the power supply module 10. Note that the detailed procedure and calculation for identifying the leakage location are disclosed in Japanese Patent Application Publication No. 2023-081523, and thus a detailed description thereof is omitted.

### (2) Leakage Determination Step S2

In the leakage determination step S2, the determination unit 130 determines whether leakage information has been received from the detection unit 120. If leakage information has not been received from the detection unit 120, the determination unit 130 then notifies that “no leakage state” exists (see S8) and terminates a diagnostic operation (No in S2). When a “no leakage state” is determined, the in-vehicle battery system 1 preferably performs the diagnostic operation again after a predetermined period has elapsed. On the other hand, if leakage information has been received from the detection unit 120, the determination unit 130 stores the leakage information in a non-volatile memory of its storage area and advances the control process to the leakage notification step S3 (see, Yes in S2). As described in detail later, the leakage information stored in the non-volatile memory remains until a countermeasure against the leakage (inspection, repair, etc.) is completed.

### (3) Leakage Notification Step S3

In the leakage notification step S3, the notification unit 400 then notifies the user of the leakage information. Specifically, the determination unit 130 transmits the leakage information to the notification unit 400 via the communication means 150. The notification unit 400 then notifies the user of the leakage information through voice or image display. This can prompt voluntary stopping and evacuation by the user, thereby reducing risks associated with leakage more suitably. In addition, by notifying the leakage information in advance, inspection and repair of the power supply module 10 can also be prompted.

### (4) Lifetime Acquisition Step S4

In the lifetime acquisition step S4, the acquisition unit 110 then acquires the degradation progression degree D of the power supply module 10 based on the usage status of the power supply module 10. As described above, a method of acquiring the degradation progression degree D may be preset by the user. For example, the “degradation progression degree D of the power supply module 10” may be a degradation progression degree of a preset component, a degradation progression degree of the most degraded component, or a degradation progression degree of a component where leakage is detected.

### (5) Lifetime Determination Step S5

In the lifetime determination step S5, the degradation progression degree D of the power supply module 10 is compared with a preset expected lifetime L. Here, when the degradation progression degree D is equal to or less than the expected lifetime L (D≤L), it is determined that the vehicle can continue running because the lifetime of the power supply module 10 has not expired. In this case, the determination unit 130 terminates the diagnostic operation (No in S5). When it is determined that the “power supply module is in a leakage state but its lifetime has not expired”, the in-vehicle battery system 1 preferably performs the diagnostic operation again after the predetermined period has elapsed. This can prevent a high-risk abnormality from occurring due to lifetime expiration of the power supply module 10 until the vehicle arrives at a repair factory after the leakage occurs.

On the other hand, when the degradation progression degree D is determined to exceed the expected lifetime L (D>L) in the lifetime determination step S5, the power supply module 10 is in a state where its lifetime has expired and leakage occurs. In this case, since a high-risk abnormality such as smoke emission or ignition may occur due to moisture intrusion from the outside, it is determined that the continuation of running of the vehicle is difficult. Also, in this case, the determination unit 130 then transmits the determination result indicating that the lifetime has ended (D>L) to the notification unit 400 and the usage stopping unit 140, and advances the control process to the stop preparation step S6 (see Yes in S5).

### (6) Stop Preparation Step S6

In the stop preparation step S6, the notification unit 400 informs the user in advance of an emergency stop. Specifically, the notification unit 400 informs the user of a predetermined evacuation time and informs in advance that the emergency stop will be performed after the evacuation time has elapsed. This allows the user to voluntarily stop and evacuate before the emergency stop, thereby preventing the occurrence of accidents due to the emergency stop.

### (7) Stop Step S7

In the stop step S7, the usage of power supplied from the power supply module 10 to the drive load 200 is stopped. Specifically, after the evacuation time has elapsed, the usage stopping unit 140 transmits a stop signal to the contactors 40. Upon receiving the stop signal, the contactors 40 are forced to be brought into an OFF state. Consequently, the supply of power from the power supply 20 to the drive load 200 can be interrupted.

As described above, the in-vehicle battery system 1 according to the present embodiment is configured to stop the usage of power supplied to the vehicle when leakage is detected and the lifetime of the power supply module 10 has expired. Thus, high-risk abnormalities such as smoke emission and ignition can be prevented. Furthermore, when the lifetime of the power supply module 10 has not expired, the in-vehicle battery system 1 does not stop the usage of power supplied to the vehicle merely because leakage is detected. Thus, risks associated with sudden stopping of the vehicle can be reduced. As described above, according to the in-vehicle battery system 1 of the present embodiment, risks associated with leakage in the power supply module 10 can be suitably reduced.

### C. Control Operation During Restart

The in-vehicle battery system 1 is preferably configured to restrict the supply of power to the drive load 200 when leakage has been detected during previous running. Thus, high-risk abnormalities can be prevented from occurring after resumption of running, thereby constructing the in-vehicle battery system 1 with enhanced safety. Details are described below.

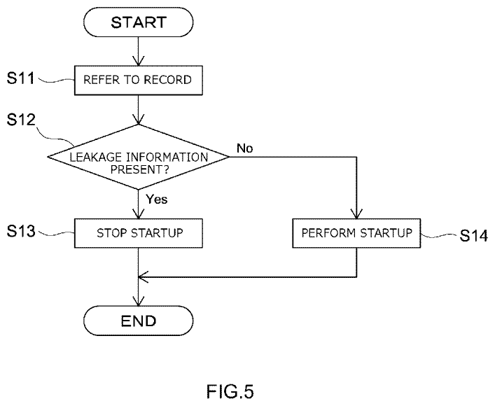

FIG. 5 is a flowchart explaining control of the in-vehicle battery system 1 at the start of running according to the first embodiment. As illustrated in FIG. 5, a control method at the start of running includes a record reference step S11, a leakage determination step S12, a startup stop step S13, and a startup start step S14.

### (1) Record Reference Step S11

In the record reference step S11, the determination unit 130 reads the non-volatile memory stored in the storage area. As described in the leakage determination step S2, the leakage information transmitted from the detection unit 120 is stored as the non-volatile memory in the storage area of the determination unit 130. At the start of running of the vehicle, the determination unit 130 reads this non-volatile memory.

(2) Leakage Determination Step S12 In the leakage determination step S12, when the vehicle is started, the determination unit 130 determines whether leakage has been detected by the detection unit 120 during the previous running. When the leakage information is confirmed in the non-volatile memory, the determination unit 130 advances the control process to the startup stop step S13 (see, Yes in S2). On the other hand, when any leakage information is not confirmed, the determination unit 130 advances the control process to the startup start step S14 (see, No in S2).

(3) Startup Stop Step S13

In the startup stop step S13, the usage stopping unit 140 stops the usage of power supplied from the power supply module 10 to the drive load 200. The usage stopping unit 140 of the present embodiment is configured to control the contactors 40 to turn OFF the connection between the power supply 20 and the drive load 200. As described above, the leakage information in the non-volatile memory remains until a countermeasure against leakage (inspection, repair, etc.) is completed. Thus, when the leakage information is confirmed in the leakage determination step S12, it is determined that leakage has been detected during the previous running and that the countermeasure against the leakage has not yet been performed. In this case, the usage stopping unit 140 stops the usage of power supplied to the drive load 200 and suspends the restart of the vehicle. This can prevent a high-risk abnormality from occurring after the resumption of running.

### (4) Startup Start Step S14

In the startup start step S14, the usage stopping unit 140 starts the supply of power from the power supply module 10 to the drive load 200. When leakage information is not confirmed in the leakage determination step S12, it is determined that leakage has not been detected during the previous running, or that a countermeasure against leakage has been appropriately performed. In this case, since the likelihood of high-risk abnormalities occurring after resumption of running is low, the usage stopping unit 140 turns ON the contactors 40 and performs the restart of the vehicle. Thereafter, the vehicle is able to run in accordance with the normal procedure.

### Other Embodiments

The first embodiment of the leakage detection method disclosed herein has been described above. However, the above-described embodiments are not intended to limit the leakage detection method disclosed herein, and various modifications can be made thereto.

For example, the detection unit 120 in the first embodiment adopts the configuration disclosed in Japanese Patent Application Publication No. 2023-081523 so as to identify the specific leakage location. However, the detection unit 120 only needs to be capable of detecting the presence or absence of leakage in the power supply module 10 and is not limited to the above configuration. For example, the in-vehicle battery system 1 may start to determine whether the degradation progression degree D exceeds the expected lifetime L when leakage is detected in any point of the conductive path 30 from the power supply module 10 to the drive load 200. Even in such a case, risks associated with leakage in the power supply module 10 can be appropriately reduced.

The power supply module 10 of the first embodiment includes the waterproof case 50 that accommodates the power supply 20, the conductive path 30, and the contactors 40. However, the waterproof case 50 is not an essential structural requirement in the technology disclosed herein. For example, when each of the components of the power supply module 10 (the power supply 20, the conductive path 30, and the contactors 40) has been individually subjected to waterproof treatment, the waterproof case 50 does not need to be provided. In such a case, the validity period of the waterproof treatment applied for each component may be regarded as the “expected lifetime L of the power supply module”.

The usage stopping unit 140 of the first embodiment transmits a stop signal to the contactors 40 when the evacuation time has elapsed after receiving, from the determination unit 130, the determination result indicating that the lifetime has ended. However, such a configuration is not an essential structural requirement in the technology disclosed herein. For example, when receiving, from the determination unit 130, the determination result indicating that the lifetime has ended, the usage stopping unit 140 may transmit, to the contactors 40, a stop signal that specifies a time difference such that “the contactors 40 are turned OFF after the evacuation time has elapsed”. Even when such a configuration is adopted, sufficient time can be ensured for the user to evacuate the vehicle. Alternatively, the usage stopping unit 140 may stop the usage of power without providing an evacuation time upon receiving, from the determination unit 130, the determination result indicating that the lifetime has ended. Since the vehicle continues to run a certain distance by inertia after stopping the usage of power, accidents due to sudden stopping can still be sufficiently suppressed.

In the in-vehicle battery system 1 according to the first embodiment, the supply of power from the power supply module 10 to the drive load 200 is interrupted by turning OFF the contactors 40 on the conductive path 30. As a result, the usage of power supplied from the power supply module 10 to the drive load 200 is stopped. However, the control of the contactor 40 is not an essential matter in the technology disclosed herein. For example, when leakage is detected by the detection unit 120 and the determination unit 130 determines that the degradation progression degree D has exceeded the expected lifetime L, the usage stopping unit 140 may transmit a vehicle emergency stop signal to the vehicle-side control device (ECU 300). Even when such a configuration is adopted, the usage of power supplied from the power supply module 10 to the drive load 200 can be stopped, thereby terminating the running of the vehicle.

Although the specific embodiments of the technology disclosed herein have been described in detail above, these are illustrative only and do not limit the scope of the claims. The technology described in the claims includes various modifications and changes to the embodiments described above. That is, the technology disclosed herein encompasses the forms described in Items 1 to 9 below.

### Item 1

1. An in-vehicle battery system including:
a power supply module connected to a drive load of a vehicle; and
a control device that controls charging and discharging of the power supply module, wherein
the control device includes:
an acquisition unit that acquires a degradation progression degree of the power supply module based on a usage status of the power supply module;
a detection unit that detects presence or absence of leakage in the power supply module;
a determination unit that determines whether the degradation progression degree exceeds a predetermined expected lifetime when leakage is detected by the detection unit; and
a usage stopping unit that stops usage of power supplied from the power supply module to the drive load when the determination unit determines that the degradation progression degree has exceeded the expected lifetime.

### Item 2

The in-vehicle battery system according to Item 1, wherein
the power supply module comprises at least:
a power supply;
a conductive path that connects the power supply to the drive load; and
a contactor provided in the conductive path and configured to switch ON and OFF a connection between the power supply and the drive load, and
the usage stopping unit controls the contactor to turn OFF the connection between the power supply and the drive load when the determination unit determines that the degradation progression degree has exceeded the expected lifetime.

### Item 3

The in-vehicle battery system according to Item 2, wherein the power supply module further includes a waterproof case that accommodates the power supply, the conductive path, and the contactor.

### Item 4

The in-vehicle battery system according to Item 3, wherein the acquisition unit regards a degradation progression degree of the waterproof case as the degradation progression degree of the power supply module.

### Item 5

The in-vehicle battery system according to any one of Items 1 to 4, wherein the acquisition unit acquires degradation progression degrees of a plurality of components included in the power supply module and regards a degradation progression degree of a component that has a highest degradation progression degree, as the degradation progression degree of the power supply module.

### Item 6

The in-vehicle battery system according to any one of Items 1 to 5, further including: a notification unit that notifies a user of leakage when the leakage is detected by the detection unit.

### Item 7

The in-vehicle battery system according to any one of Items 1 to 6, wherein the degradation progression degree is calculated based on at least one selected from the group consisting of a cumulative operating time of the in-vehicle battery system, a cumulative running distance of the vehicle, and a cumulative charge-discharge current integrated value of the power supply module.

### Item 8

The in-vehicle battery system according to any one of Items 1 to 7, wherein the usage stopping unit stops usage of power supplied from the power supply module to the drive load after a predetermined evacuation time is elapsed when the determination unit determines that the degradation progression degree has exceeded the expected lifetime.

### Item 9

The in-vehicle battery system according to any one of Items 1 to 8, wherein
the determination unit determines whether leakage has been detected by the detection unit during previous running, when the vehicle is started, and
the usage stopping unit stops usage of power supplied from the power supply module to the drive load when the determination unit determines that the leakage has been detected during the previous running.

1. An in-vehicle battery system comprising:
a power supply module connected to a drive load of a vehicle; and
a control device that controls charging and discharging of the power supply module, wherein
the control device comprises:
an acquisition unit that acquires a degradation progression degree of the power supply module based on a usage status of the power supply module;
a detection unit that detects presence or absence of leakage in the power supply module;
a determination unit that determines whether the degradation progression degree exceeds a predetermined expected lifetime when leakage is detected by the detection unit; and
a usage stopping unit that stops usage of power supplied from the power supply module to the drive load when the determination unit determines that the degradation progression degree has exceeded the expected lifetime.

2. The in-vehicle battery system according to claim 1, wherein
the power supply module comprises at least:
a power supply;
a conductive path that connects the power supply to the drive load; and
a contactor provided in the conductive path and configured to switch ON and OFF a connection between the power supply and the drive load, and
the usage stopping unit controls the contactor to turn OFF the connection between the power supply and the drive load when the determination unit determines that the degradation progression degree has exceeded the expected lifetime.

3. The in-vehicle battery system according to claim 2, wherein the power supply module further comprises a waterproof case that accommodates the power supply, the conductive path, and the contactor.

4. The in-vehicle battery system according to claim 3, wherein the acquisition unit regards a degradation progression degree of the waterproof case as the degradation progression degree of the power supply module.

5. The in-vehicle battery system according to claim 1, wherein the acquisition unit acquires degradation progression degrees of a plurality of components included in the power supply module and regards a degradation progression degree of a component that has a highest degradation progression degree, as the degradation progression degree of the power supply module.

6. The in-vehicle battery system according to claim 1, further comprising: a notification unit that notifies a user of leakage when the leakage is detected by the detection unit.

7. The in-vehicle battery system according to claim 1, wherein the degradation progression degree is calculated based on at least one selected from the group consisting of a cumulative operating time of the in-vehicle battery system, a cumulative running distance of the vehicle, and a cumulative charge-discharge current integrated value of the power supply module.

8. The in-vehicle battery system according to claim 1, wherein the usage stopping unit stops usage of power supplied from the power supply module to the drive load after a predetermined evacuation time is elapsed when the determination unit determines that the degradation progression degree has exceeded the expected lifetime.

9. The in-vehicle battery system according to claim 1, wherein
the determination unit determines whether leakage has been detected by the detection unit during previous running, when the vehicle is started, and
the usage stopping unit stops usage of power supplied from the power supply module to the drive load when the determination unit determines that the leakage has been detected during the previous running.
